(19) United States
(12) Patent Application Publication
(10) Pub. No.: US 2009/0026952 A1
(43) Pub. Date: Jan. 29, 2009

(54) PHOSPHOR PASTE AND PLASMA DISPLAY PANEL USING THE SAME

(76) Inventor: Sang Bum AHN, Seongnam-si (KR)

Correspondence Address: KED & ASSOCIATES, LLP, P.O. Box 221200, Chantilly, VA, 20153-1200, US

(21) Appl. No.: 12/141,979

(22) Filed: Jun. 19, 2008

(30) Foreign Application Priority Data
Jul. 24, 2007 (KR) 10-2007-0074081

(51) Int. Cl. H01J 17/49; B05D 5/06

(52) U.S. Cl. 313/582; 427/67

(57) ABSTRACT

A phosphor paste and a plasma display panel using the same are provided. The phosphor paste includes a vehicle made of an organic binder and a solvent, a phosphor powder, and a thermal decomposition catalyst. The thermal decomposition catalyst mediates oxidative thermal decomposition of the organic binder. The thermal decomposition catalyst may include Zeolite and a metal oxide nanopowder with a particle size of 10 to 1,000 nm.

This application claims the benefit of Korean Patent Application No.10-2007-0074081, filed in Korea on Jul. 24, 2007, which is hereby incorporated by reference as if fully set forth herein.

### BACKGROUND

1. Field

This relates to a plasma display panel, and more particularly, to a phosphor paste and a plasma display panel using the same.

2. Background

With the advent of the multimedia age, there has been a demand for displays that can exhibit higher definition, have a larger screen and render colors more approximate to natural colors. Since cathode ray tubes (CRTs) are unable to produce a relatively large screen size (i.e., 40 inch or more) of relatively light weight, displays such as liquid crystal displays (LCDs), plasma display panels (PDPs) and projection televisions (TVs) are being rapidly developed so that their applications can be extended to the high-quality image field.

A plasma display panel (PDP) is an electronic device which uses a plasma discharge to display images. When a predetermined voltage is applied to electrodes arranged in a discharging space of the PDP, a plasma discharge occurs between the electrodes. Vacuum ultra violet (VUV) emissions generated during this plasma discharge excites phosphor layers formed in a predetermined pattern to thereby form an image. These phosphor layers may be produced by preparing a phosphor paste composition and applying the phosphor paste composition to a substrate, followed by baking and drying.

However, organic residues left on the phosphor layers after baking may cause a deterioration in phosphor properties. This deterioration in phosphor properties may lead to degradation in color characteristics, as well as degradation in overall brightness and luminescence efficiency of PDPs.

### BRIEF DESCRIPTION OF THE DRAWINGS

The embodiments will be described in detail with reference to the following drawings in which like reference numerals refer to like elements wherein:

FIG. 1 is a flow chart of a process for preparing a phosphor paste and then producing a phosphor layer of a plasma display panel as embodied and broadly described herein;

FIG. 2 is a graph comparing thermal decomposition temperature and organic residue level between Examples 1 and 2, and a Comparative Example;

FIG. 3 is a graph comparing optical properties between Examples 1 and 2 and the Comparative Example;

FIG. 4 is a sectional view of a plasma display panel as embodied and broadly described herein;

FIG. 5 illustrates a driver and a connection part of the plasma display panel shown in FIG. 4;

FIG. 6 illustrates a wiring substrate of a tape carrier package (TCP);

FIG. 7 is a schematic view of an alternative embodiment of the TCP shown in FIG. 6;

FIGS. 8A to 8K illustrate a method of fabricating a plasma display panel as embodied and broadly described herein;

FIG. 9A illustrates a process for joining a front substrate and a lower substrate of a plasma display panel; and

FIG. 9B is a sectional view taken along line A-A′ of FIG. 9A.

### DETAILED DESCRIPTION

Reference will now be made in detail to embodiments, examples of which are illustrated in the accompanying drawings.

In order to minimize organic residues left behind on phosphor layers after baking, a phosphor paste as embodied and broadly described herein may include a thermal decomposition catalyst capable of mediating or facilitating oxidative thermal decomposition of the organic materials.

That is, such a phosphor paste may include a vehicle comprising or consisting of an organic binder and a solvent, a phosphor powder and a thermal decomposition catalyst. The thermal decomposition catalyst may mediate oxidative thermal decomposition of the organic material of the organic binder. The thermal decomposition catalyst may include at least one of Zeolite and a metal oxide nanopowder.

For example, the phosphor paste may include about 20 to 90% by weight of a vehicle, about 10 to 80% by weight of a phosphor powder, and about 0.001 to 36% by weight of a thermal decomposition catalyst. The vehicle may comprise or consist of about 5 to 80% by weight of an organic binder and about 20 to 95% by weight of a solvent. The organic binder herein used may be an organic polymer including cellulose-based polymers, acryl-based polymers, vinyl-based polymers, or the like.

The cellulose-based polymers that may be used in the organic binder may include methyl, ethyl, nitrocellulose, or the like. The acryl-based polymers include polymethylmethacrylate, polymethylacrylate, polyethylacrylate, polyethylmethacrylate, polynormalpropylacrylate, polynormalpropylmethacrylate, polyisopropylacrylate, polyisoporpylmethacrylate, polynormalbutylacrylate, polynormalbutylmethacrylate, polycyclohexylacrylate, polycyclohexylmethacrylate, polylautylacrylate, polylaurylmethacrylate, polystearylacrylate, polystearylmethacrylate, or the like. These acryl-based polymers may be used singly or as a copolymer thereof.

Furthermore, the vinyl-based polymers that may be used in the organic binder may include polyethylene, polypropylene, polystyrene, polyvinylalcohol, polybutylacetate, polyvinylpyrrolidone, or the like. These polymers may be used alone, or if necessary, in combination thereof.

Any solvent or equivalent thereof may be used so long as it is capable of dissolving organic polymers, such as cellulose-based polymers, acryl-based polymers, vinyl-based polymers, or the like. Examples of the solvent include: organic solvents such as benzenes, alcohols, chloroform, esters, cyclohexanone, N,N-dimethylacetamide, or acetonitrile; or aqueous solvents such as water, an aqueous potassium sulfate solution or an aqueous magnesium sulfate solution. These solvents may be used alone or in combination thereof.

The phosphor powder may include a blue phosphor material, a green phosphor material or a red phosphor material. For example, the red phosphor material may be Y(V,P)O4:Eu or (Y,Gd)OB3:Eu, and the green phosphor material may be one of Zn2SiO4:Mn, (Zn,A)2SiO4:Mn (in which “A” is an alkaline metal) and/or combinations thereof.

In addition, the green phosphor material may be used in combination with at least one phosphor material selected from BaAl2O19:Mn, (Ba, Sr, Mg)OaAl2O3:Mn (in which “a” is an integer of 1 to 23), MgAlxOy:Mn (in which “x” is an integer of 1 to 10, and “y” is an integer of 1 to 30), LaMgAlxOy:Tb,Mn (in which “x” is an integer of 1 to 14, and “y” is an integer of 8 to 47), and/or ReBO3:Tb (Re is at least one rare earth element selected from Sc, Y, La, Ce and/or Gd).

The blue phosphor material may be BaMgAl10O17:Eu, CaMgSi2O6:Eu, CaWO4:Pb, Y2SiO5:Eu, or a combination thereof.

The thermal decomposition catalyst may be Zeolite, a metal oxide nanopowder or a combination thereof.

In the case where Zeolite is exclusively used for the thermal decomposition catalyst, the Zeolite may be used in an amount of about 0.1 to 50% by weight, based on the weight of the organic binder.

The Zeolite may be Zeolite A, Zeolite X, Y, Zeolite ZSM-5, Zeolite ZSM-11, Mordenite, habazite and/or combinations thereof.

Meanwhile, in the case where a metal oxide nanopowder is exclusively used for the thermal decomposition catalyst, the metal oxide nanopowder may be used in an amount of about 0.1 to 70% by weight, based on the weight of the organic binder.

The metal oxide nanopowder may have a nanoscale particle size of about 10 to about 1,000 nm.

The metal oxide nanopowder may be at least one selected from Al203, 3Al2O3, 2SiO2, Al2O3ZrO2, ZrO4, TiSiO4, Al2O3TiO2, MgO and/or SiO2.

Meanwhile, in the case where a mixture of Zeolite and a metal oxide nanopowder is used as the thermal decomposition catalyst, the Zeolite and the metal oxide nanopowder may be used in amounts of about 0.1 to 50% by weight and about 0.1 to 70% by weight, respectively, based on the weight of the organic binder.

For example, the mixture of Zeolite and a metal oxide nanopowder used as the thermal decomposition catalyst may comprise or may consist of about 1 to 60% by weight of Zeolite and about 40 to 99% by weight of the metal oxide nanopowder.

In certain embodiments, the mixture consists of about 30 to 40% by weight of Zeolite and about 60 to 70% by weight of the metal oxide nanopowder.

The mixture of Zeolite and a metal oxide nanopowder may have a composition of 100:0.001 to 0.001:100.

As such, the content of the thermal decomposition catalyst may be about 0.1 to 70% by weight, based on the weight of the organic binder, and about 0.001 to 36% by weight, based on the total weight of the phosphor paste.

At least one reason for the content range of the thermal decomposition catalyst is as follows. When the content of the thermal decomposition catalyst is less than about 0.1% by weight, based on the weight of the organic binder, organic materials may remain on phosphor layers after baking, thus causing deterioration of color characteristics of the phosphor layers. On the other hand, when the content of the thermal decomposition catalyst exceeds about 70% by weight, based on the weight of the organic binder, stability and printability of the phosphor composition may be degraded.

In addition to the vehicle, phosphor powder and thermal decomposition catalyst, a phosphor paste as embodied and broadly described herein may also include an additive such as an acryl-based dispersant for improving flowability of the phosphor paste, a silicone-based antifoaming agent, a leveling agent, an antioxidant, a plasticizer such as dioctylphthalate, and the like. The additive may be contained in an amount of about 0.1 to 5% by weight, based on the total weight of the phosphor composition. This is because, when the content of the additive exceeds about ⁵% by weight, based on the total weight of the phosphor composition, printability may be degraded.

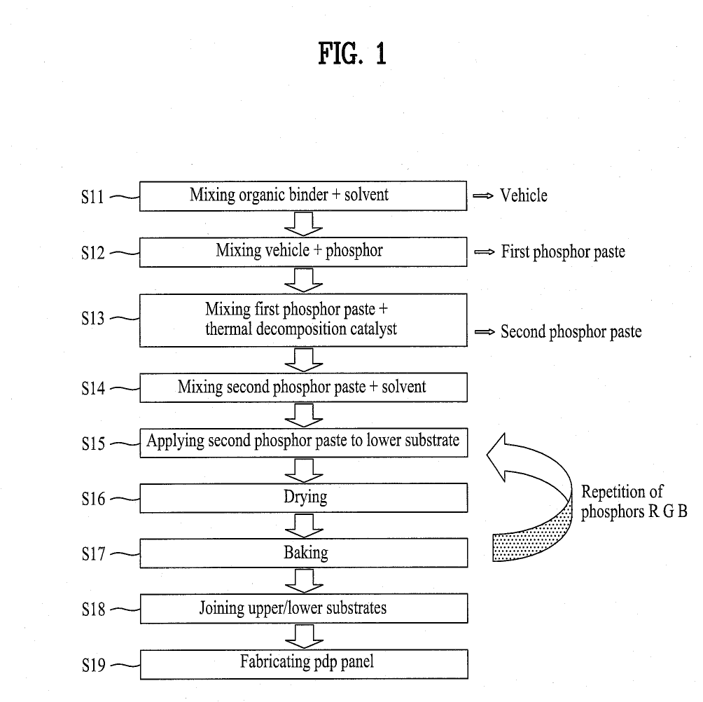

FIG. 1 is a flow chart of a process for preparing a phosphor paste and then forming a phosphor layer of a plasma display panel as embodied and broadly described herein.

As shown in FIG. 1, first, an organic binder is mixed with a solvent to prepare a vehicle (S11). The vehicle may be prepared by mixing about 5 to 80% by weight of the organic binder and about 20 to 95% by weight of the solvent. The organic binder may be an organic polymer selected from cellulose-based polymers, acryl-based polymers, vinyl-based polymers, and the like. The solvent may be selected from organic solvents such as benzenes, alcohols, chloroform, esters, cyclohexanone, N,N-dtitethylacetamide, or acetonitrile; and aqueous solvents such as water, an aqueous potassium sulfate solution or an aqueous magnesium sulfate solution. In addition, the solvent may be used alone or in combination thereof.

Then, a phosphor powder is mixed with the vehicle to prepare a first phosphor paste (S12). The first phosphor paste may be prepared by mixing about 20 to 90% by weight of the vehicle with about 10 to 80% by weight of the phosphor powder. The phosphor powder may use Y(V,P)O4:Eu or (Y,Gd)BO3:Eu, as a red phosphor material, and may use one of Zn2SiO4:Mn, (Zn,A)2SiO4:Mn (in which “A” is an alkaline metal) and/or combinations thereof, as a green phosphor material. In addition, the phosphor powder, as a green phosphor material, may use BaMgAl10O17:Eu, CaMgSi2O6:Eu, CaWO4:Pb, Y2SiO5:Eu, or a combination thereof.

Subsequently, a thermal decomposition catalyst is mixed with the first phosphor paste to prepare a second phosphor paste (S13). The second phosphor paste may be prepared by mixing about 64 to 99.999% by weight of the first phosphor paste with about 0.001 to 36% by weight of the thermal decomposition catalyst. The thermal decomposition catalyst may be Zeolite, a metal oxide nanopowder or a combination thereof.

Then, a solvent is mixed with the second phosphor paste (S14). The second phosphor paste and the solvent may be mixed in amounts of about 5 to 80% by weight and about 20 to 95% by weight, respectively.

Then, the resulting second phosphor paste is applied to discharge cells of a lower substrate of a plasma display panel to form a phosphor layer (S15). Application of the phosphor layer may be carried out by one selected from a screen printing method, a doctor blade method, a dip method, a reverse roll method, a direct roll method, a gravure method, an extrusion method, a brush method, and the like. In certain embodiments, the use of the screen printing method may be preferred.

Subsequently, the phosphor layer is dried and baked to remove organic residues left thereon (S16, S17). The applying, drying and baking steps (S15, S16, S17) may be repeated as necessary to apply red, green and blue phosphors.

The drying of the phosphor layer may be carried out at a temperature ranging from about 50° C. to about 250° C. for about 5 to 90 minutes. The baking of the dried phosphor layer may be carried out at a temperature ranging from 300° C. to 600° C. for about 30 to 60 minutes, under vacuum or inert gas atmosphere. In certain embodiments, the baking is performed at a low temperature of about 400° C. to about 550° C. for about 30 to 60 minutes. When the baking is performed at an excessively low temperature or for an excessively short time, organic materials cannot be completely removed from the phosphor layer. Meanwhile, when the baking is performed at an excessively high temperature or for an excessively long time, the phosphor layer may be degraded.

After drying and baking, a composition of the resulting phosphor layer may include the Zeolite and the metal oxide nanopowder that form the thermal decomposition catalyst, and the phosphor powder. The resulting phosphor layer may include 0.001 to 36% by weight of the thermal decomposition catalyst, and 64 to 99.99% by weight of the phosphor powder, and the thermal decomposition catalyst remaining in the resulting phosphor layer may include 30 to 40% by weight of the Zeolite and 60 to 70% by weight of the metal oxide nanopowder. Thus, the resulting phosphor layer may include 3 to 14.4% by weight of the Zeolite, 6 to 25.2% by weight of the metal oxide nanopowder, and 64 to 99.99% of the phosphor powder.

Then, upper and lower substrates of the panel are joined together to complete fabrication of a plasma display panel (S18, S19). Examples 1 and 2 and a Comparative Example using the phosphor paste and phosphor layer produced as described above will now be discussed.

### EXAMPLE 1

A vehicle comprising or consisting of (1) about 80% by weight of butyl carbitol acetate as a solvent and about 20% by weight of ethyl cellulose as an organic binder; (2) a green phosphor of about 40% by weight of Zn2SiO4:Mn; and (3) a thermal decomposition catalyst of about 10% by weight of a mixture of Zeolite and Al2O3TiO2 was prepared. Then, these ingredients were mixed together to prepare a phosphor paste. Subsequently, the phosphor paste was applied to a lower substrate using a screen printing method to produce a phosphor layer. The phosphor layer was dried at about 100° C. for about 60 minutes and then baked at about 500° C. for about 50 minutes under argon gas atmosphere.

### EXAMPLE 2

A vehicle comprising or consisting of (1) about 80% by weight of acrylate as a solvent and about 20% by weight of ethyl cellulose as an organic binder; (2) a green phosphor of about 40% by weight of Zn2SiO4:Mn; and (3) a thermal decomposition catalyst of about 10% by weight of a mixture of Zeolite and Al2O3TiO2 was prepared. Then, these ingredients were mixed together to prepare a phosphor paste. Subsequently, the phosphor paste was applied to a lower substrate using a screen printing method to produce a phosphor layer. The phosphor layer was dried at about 100° C. for about 60 minutes and then baked at about 500° C. for about 50 minutes under argon gas atmosphere.

### COMPARATIVE EXAMPLE

A vehicle comprising or consisting of (1) about 80% by weight of butyl carbitol acetate as a solvent and about 20% by weight of ethyl cellulose as an organic binder; and (2) a green phosphor of about 80% by weight of Zn2SiO4:Mn was prepared. Then, these ingredients were mixed together to prepare a phosphor paste. Subsequently, the phosphor paste was applied to a lower substrate using a screen printing method to produce a phosphor layer. The phosphor layer was dried at about 100° C. for about 60 minutes and then baked at about 500° C. for about 50 minutes under argon gas atmosphere.

The phosphor layers of Examples 1 and 2 produced from the phosphor paste including the thermal decomposition catalyst were compared with the phosphor layer of the Comparative Example that did not include a thermal decomposition catalyst. The differences between the phosphor layers are shown in Table 1 below.

TABLE 1

| | Brightness | Luminescence | Organic residue |
|---|---|---|---|
| | (%) | efficiency (%) | (%) |
| Example 1 | 110 | 111 | 0.12 |
| Example 2 | 120 | 116 | 0.8 |
| Comparative | 100 | 100 | 6.71 |
| Example | | | |

As can be seen from Table 1 above, the brightness and luminescence efficiency of green light emitted from the plasma display panel of Examples 1 and 2 are superior to that of the Comparative Example, and the organic residue of Examples 1 and 2 is lower than that of Comparative Example.

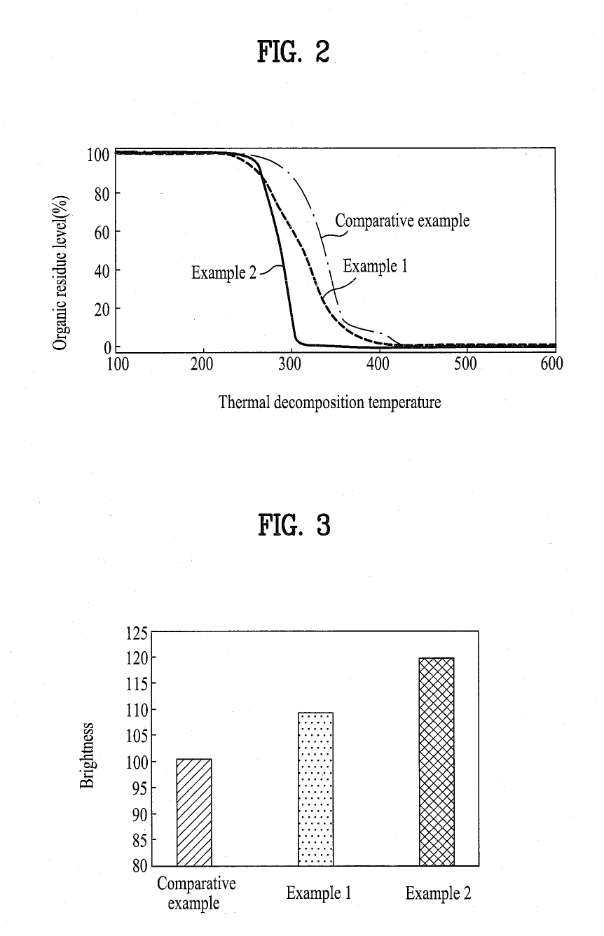

FIG. 2 is a graph comparing thermal decomposition temperatures and organic residue levels of Examples 1 and 2 and the Comparative Example. FIG. 3 is a graph comparing optical properties of Examples 1 and 2 and the Comparative Example.

The graph of FIG. 2 is obtained by thermogravimetry. As can be seen from FIG. 2, the phosphors layers obtained in Examples 1 and 2 undergo rapid thermal decomposition due to low thermal decomposition temperature, and furthermore show a low organic residue level, as compared to those of the Comparative Example.

The graph of FIG. 3 is obtained using photoluminescence (PL) equipment. As can be seen from FIG. 3, Examples 1 and 2 exhibit high brightness and high efficiency, as compared to those of the Comparative Example.

As such, when phosphor layers are produced from a phosphor paste that includes a thermal decomposition catalyst, the thermal decomposition catalyst promotes thermal decomposition of organic materials during baking, thus making the level of organic residues as low as possible.

Consequently, the minimization of the level of organic residues left in the phosphor layer thus produced improves phosphor color characteristics, thus leading to enhancement in overall brightness and luminescence efficiency of plasma display panels including such a phosphor paste.

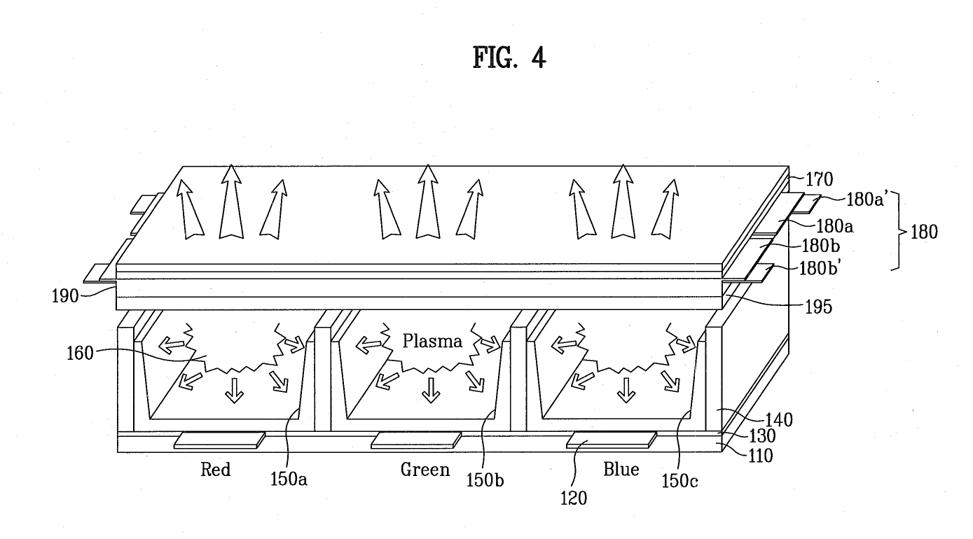

FIG. 4 is a sectional view of a plasma display panel as embodied and broadly described herein. As shown in FIG. 4, the plasma display panel may include sustain electrode pairs 180 arranged on a front substrate 170. Each of the sustain electrode pairs 180 includes a pair of transparent electrodes 180a and 180b and a pair of bus electrodes 180a′ and 180b′.

The plasma display panel may also include a dielectric layer 190 and a passivation film 195 arranged in this order over the entire surface of the front substrate 170 including the sustain electrode pairs 180. The front substrate 170 may be formed by processing a glass for display substrates. The glass may be processed by milling, cleaning, and the like.

The transparent electrodes 180a and 180b may be formed by sputtering a material such as indium-tin-oxide (ITO) or SnO2 on the front substrate 170, followed by photo-etching. Alternatively, the transparent electrodes 180a and 180b may be formed by subjecting this material to chemical vapor deposition (CVD), followed by lift-off.

The bus electrodes 180a′ and 180b′ may be made of general-purpose conductive metals and precious metals. Examples of the general-purpose conductive metals include aluminum (Al), copper (Cu), nickel (Ni), chromium (Cr), molybdenum so), or the like. Examples of the precious metals include silver (Ag), gold (Au), platinum (Pt), iridium (Ir), or the like. Subsequently, the general-purpose conductive metal is combined with the precious metal in a manner such that the general-purpose metal forms a core and the precious metal forms a shell enveloping the surface of the core.

The dielectric layer 190 may be arranged over the front substrate 170 provided with the transparent electrodes 180a and 180b and the bus electrodes 180a′ and 180b ′. The dielectric layer 190 may be made of a transparent glass having a low melting point. The passivation film 195 may be made of magnesium oxide and may be arranged on the dielectric layer 190. The passivation film 195 functions to protect the dielectric layer 190 from an impact of positive (+) ions during an electrical discharge, and increase the emission of secondary electrons.

Address electrodes 120 may be arranged on one surface of a rear substrate 110 such that they extend in a direction perpendicular to the extension direction of the sustain electrode pairs 180. A white dielectric layer 130 may also be arranged over the entire surface of the rear substrate 110 including the address electrodes 120. The address electrodes 120 may be made of general-purpose conductive metals and precious metals as the above-described bus electrodes 180a′ and 180b′. Examples of the general-purpose conductive metals include aluminum (Al), copper (Cu), nickel (Ni), chromium (Cr), molybdenum Mo), or the like. Examples of the precious metals include silver (Ag), gold (Au), platinum (Pt), iridium (Ir), or the like.

The formation of the white dielectric layer 130 may be carried out by applying materials to the rear substrate 110 via printing or film laminating, followed by baking. Then, barrier ribs 140 may be arranged on the white dielectric layer 130. The barrier ribs 140 may be a stripe-type, a well-type, a delta-type, or other type as appropriate. The barrier ribs 140 may be made of a parent glass and a porous filler. Parent glasses are classified into leaded parent glasses and unleaded parent glasses. Examples of the leaded parent glasses may include ZnO, PbO and B2O3, and examples of the unleaded parent glasses may include ZnO, B2O3, BaO, SrO and CaO. The barrier ribs 140 may also include an oxide such as SiO2, Al2O3, or the like as the filler.

Red (R), green (G), and blue (B) phosphor layers 150a, 150b and 150c may be arranged between the adjacent barrier ribs 140.

In order to minimize organic resides left in the phosphor layers after baking, a thermal decomposition catalyst may be used to prepare a phosphor paste. That is, in addition to a vehicle comprising or consisting of an organic binder and a solvent, and a phosphor powder, the phosphor paste may also include a thermal decomposition catalyst comprising or consisting of at least one of Zeolite or a metal oxide nanopowder in order to promote oxidative thermal decomposition of organic materials.

The phosphor layers 150a, 150b and 150c may also include a pigment. The reason for including a pigment is to improve the bright-room contrast of PDPs by reducing the reflectance of incident light. The pigment itself may serve as a color filter, thereby improving the color purity and the color coordinate. The pigment contained in the phosphor layers may be an iron oxide pigment, a cobalt green pigment, an emerald green pigment, a chromium oxide green pigment, a chromium-alumina green pigment, a Victoria green pigment, a cobalt blue pigment, a Prussian pigment, a Turkey blue pigment, Co—Zn—Si pigment, and the like. The pigment contained in the phosphor layers may be selected from α-Fe2O3, (Co,Zn)O.(Al,Cr)2O3, 3CaO—Cr2O3 3SiO2, (Al,Cr)2O3, CoOAl2O3, 2(Co,Zn)O.SiO2, ZrSiO4, and the like.

The drying of the phosphor layers 150a, 150b and 150c may be carried out at a temperature ranging from about 50° C. to about 250° C. for about 5 to 90 minutes. The baking of the dried phosphor layers 150a, 150b and 150c may be carried out at a temperature ranging from 300° C. to 600° C. for about 30 to 60 minutes under vacuum or inert gas atmosphere. In certain embodiments, the baking is performed at a low temperature of about 400° C. to about 550° C. for about 30 to 60 minutes.

After completion of forming the phosphor layers 150a, 150b and 150c, the front substrate 170 and the rear substrate 110 are joined together through sealants arranged at the edges of the substrates 170 and 110 such that the barrier ribs 140 are interposed between the front substrate 170 and the rear substrate 110.

The upper panel and lower panel are then connected to a driver.

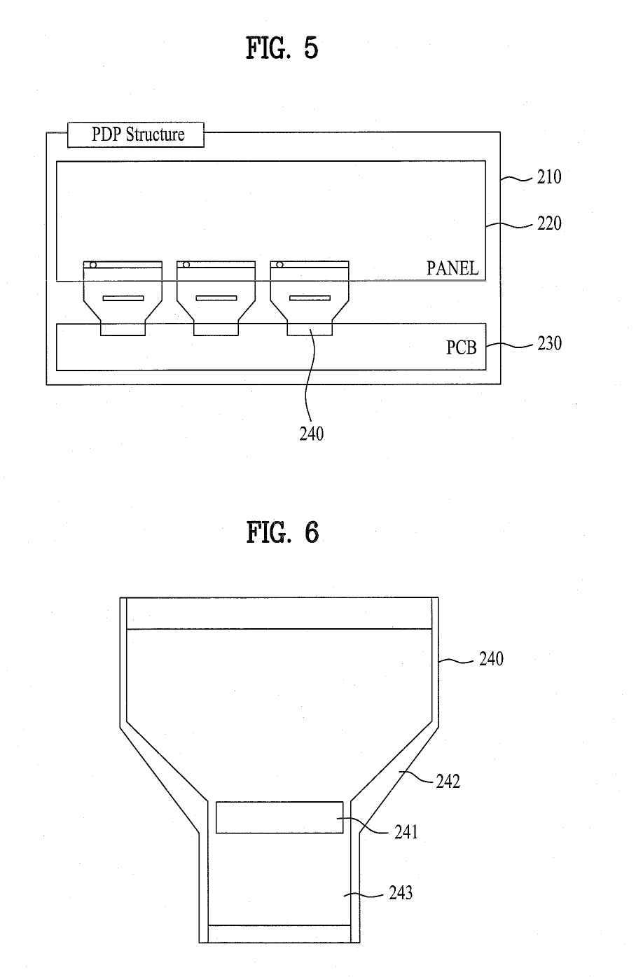

FIG. 5 illustrates a driver and a connection part of a plasma display panel as embodied and broadly described herein.

As shown in FIG. 5, the overall plasma display panel structure 210 may include a panel 220, a drive substrate 230 to supply a drive voltage to the panel 220, and a tape carrier package 240 (hereinafter, referred to as “TCP”) to connect the drive substrate 230 to the electrodes arranged at each of discharge cells of the panel 220. As mentioned above, the panel 220 may include a front substrate 170, a rear substrate 110 and barrier ribs 140.

An anisotropic conductive film (hereinafter, referred to as “ACF”) may be used to electrically and physically connect the panel 220 to the TCP 240, and to electrically and physically connect the TCP 240 to the drive substrate 230. The ACF may be a conductive resin film prepared from balls made of gold (Au)-coated nickel (Ni).

FIG. 6 illustrates the structure of a wiring substrate of the tape carrier package (TCP) 240. As shown in FIG. 6, the TCP 240 may provide for wiring between the panel 220 and the driving substrate 230, and may include a driver chip 241 mounted on the TCP 240. The TCP 240 may include a flexible substrate 242, a line 243 arranged on the flexible substrate 242, and a driver chip 241 connected to the line 243, to receive power from the drive substrate 230 and to supply power to a specific electrode of the panel 220.

The driver chip 241 may receive a low voltage and a small number of drive control signals and alternatively output a large number of signals with a high power. For this reason, a small number of lines 243 may be connected to the drive substrate 230, while a large number of lines 243 may be connected to the panel 220.

In some cases, the space adjacent to the drive substrate 230 may be used to connect the drive substrate 230 to the driver chip 241. For this reason, the line 243 may be provided in the center of the driver chip 241.

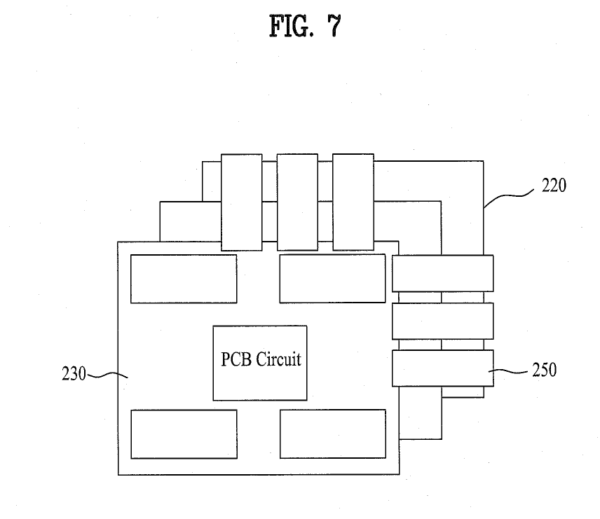

FIG. 7 is a schematic view illustrating an alternative embodiment of the TCP shown in FIG. 6. In this embodiment, the panel 220 is connected to the drive substrate 230 through a flexible printed circuit 250 (hereinafter, referred to as “FPC”). The FPC 250 may be a film whose internal pattern is formed of a polyitide. In this embodiment, the FPC 250 and the panel 220 may be connected to each other through the ACF.

Thus, the drive substrate 230 used herein may be a PCB circuit. The driver may include a data driver, a scan driver and a sustain driver. The data driver may be connected to an address electrode to apply a data pulse, the scan driver may be connected to a scan electrode to supply ramp-up waveform, ramp-down waveform, a scan pulse and a sustain pulse. The sustain driver applies sustain pulses and a DC voltage to a common sustain electrode.

The total operation time of the plasma display panel may be divided into a reset period, an address period and a sustain period. During the reset period, ramp-up waveforms may be concurrently applied to the scan electrodes. During the address period, negative scan pulses may be sequentially applied to the scan electrodes, and at the same time, may be synchronized with scan pulses and then apply positive data pulses to address electrodes. During the sustain period, sustain pulse may be alternatively applied to the scan electrodes and the sustain electrodes.

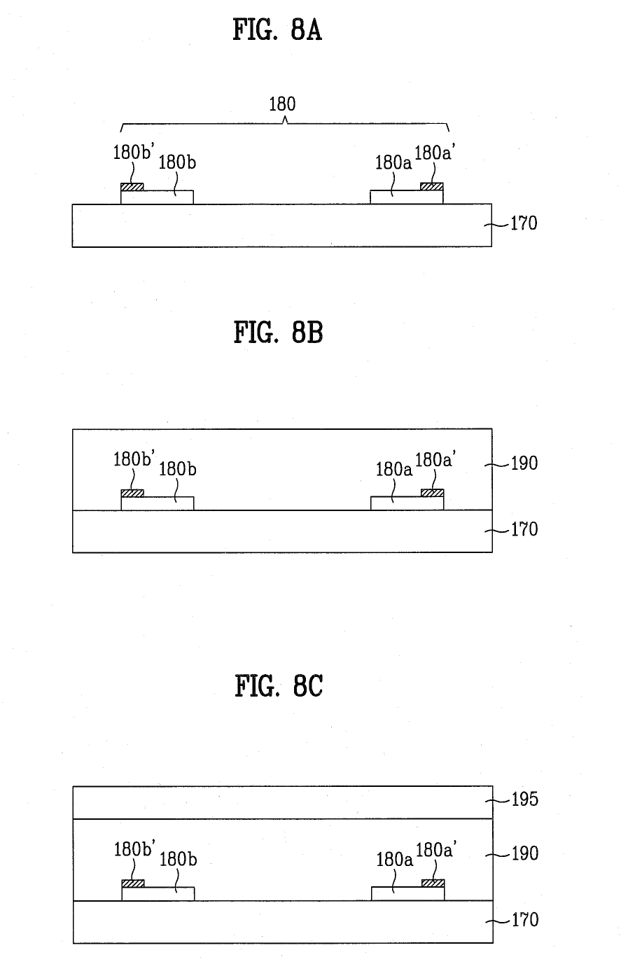

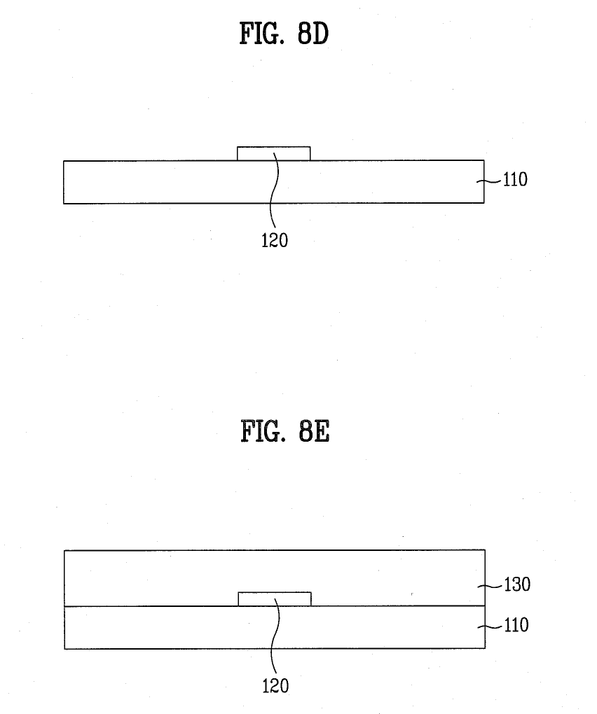

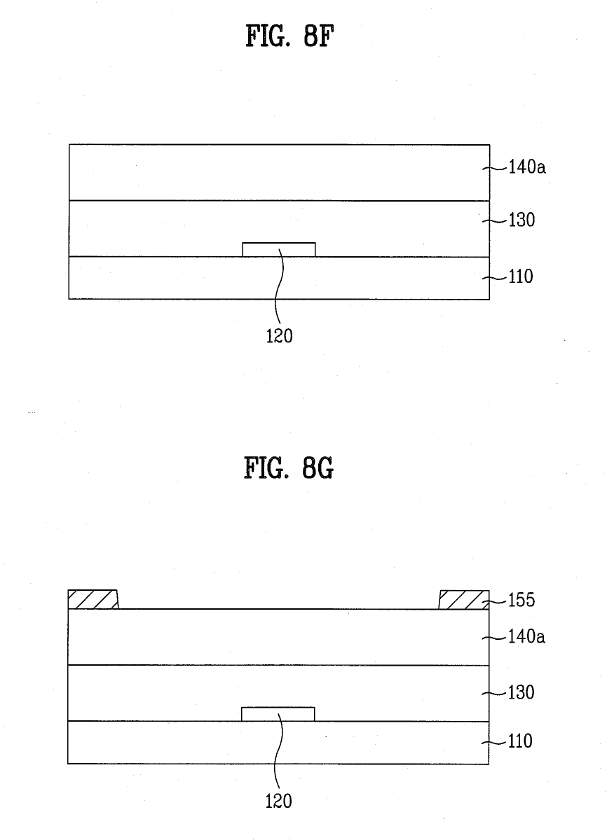

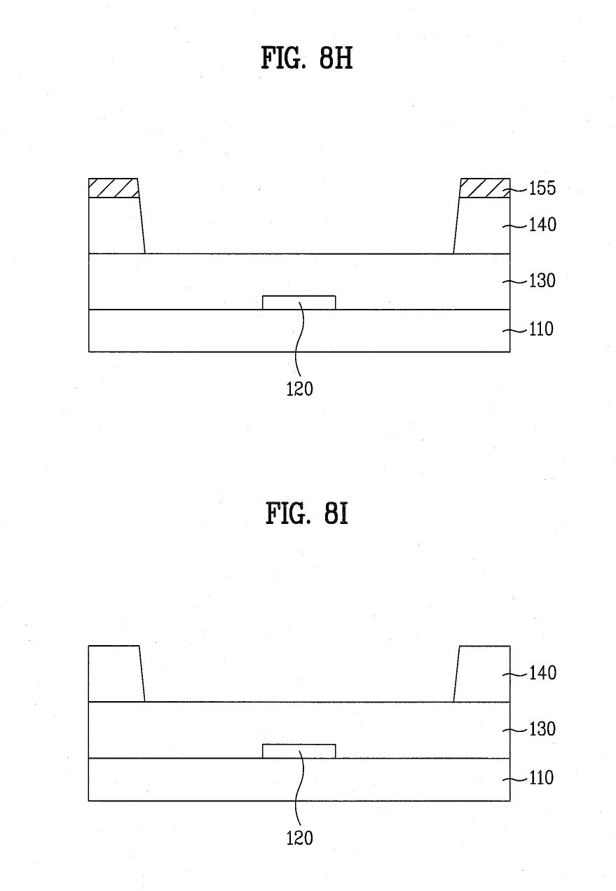

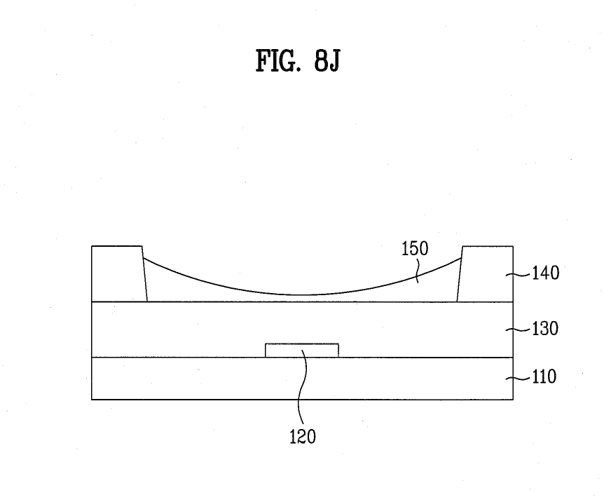

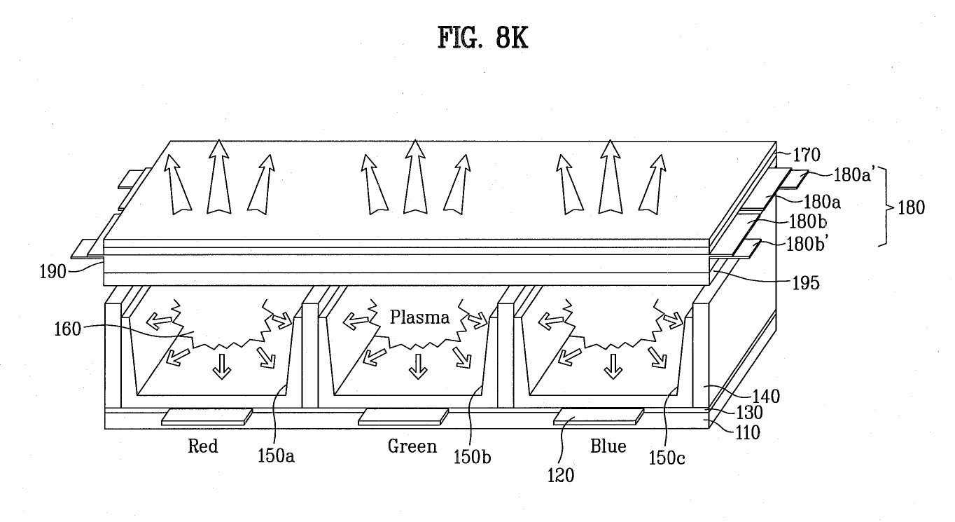

FIGS. 8A to 8K illustrate a method for fabricating a plasma display panel as embodied and broadly described herein.

As shown in FIG. 8A, sustain electrode pairs 180 provided with transparent electrodes 180a and 180b, and bus electrodes 180a′ and 180b′ may be formed on a front substrate 170. The front substrate 170 may be produced by milling a soda lime glass, followed by cleaning. The transparent electrodes 180a and 180b may be formed by sputtering a material such as indium-tin-oxide (ITO) or SnO2 on the front substrate 170, followed by photo-etching. Alternatively, the transparent electrodes 180a and 180b may be formed by subjecting the material to chemical vapor deposition (CVD), followed by lift-off. Alternatively, these steps may be omitted if the transparent electrodes 180a and 180b are not required.

Then, the bus electrodes 180a′ and 180b′ may be formed from general-purpose conductive metals and precious metals, as described above. The material for the bus electrodes 180a′ and 180b′ may be in the form of a paste prepared by mixing general-purpose conductive metals and precious metals. The material may have a core-shell structure in which the surface of a core made of a general-purpose metal is covered with a shell made of a precious metal.

Then, as shown in FIG. 8B, a dielectric layer 190 may be formed over the entire surface of the front substrate 170 including the transparent electrodes 180a and 180b, and the bus electrodes 180a′ and 180b′. The formation of the dielectric layer 190 may be performed by screen printing or coating a material such as a transparent glass with a low melting point, or by laminating a green sheet. Thereafter, the bus electrodes 180a′ and 180b′, and the dielectric layer 190 may be baked through separate steps, or a one-step for the purpose of simplification of an overall process.

In certain embodiments, the baking temperature is in the range of 500° C. to 600° C. When the bus electrodes and the dielectric layer are baked together, the dielectric layer intercepts between the bus electrodes and oxygen, and thus lowers the amount of the bus electrode material to be oxidized.

As shown in FIG. 8C, a passivation film 195 may be deposited over the dielectric layer 190. The passivation film 195 may be made of magnesium oxide. The protective film 195 may include a dopant, e.g., silicon (Si). The protective film 195 may be formed by chemical vapor deposition (CVD), E-beam, ion-plating, a sol-gel method, a sputtering method, and the like.

Then, as shown in FIG. 8D, an address electrode 120 may be formed on a rear substrate 110. The rear substrate 110 may be formed by milling or cleaning a glass for display substrates or a soda-lime glass. The address electrode 120 may be formed by a screen-printing method, a photosensitive-paste method, or a photo-etching method following sputtering, using a material such as silver (Ag). The address electrode 120 may be formed using materials such as general-purpose conductive metals and precious metals and a more detailed description thereof is the same as the above-described bus electrodes.

Then, as shown in FIG. 8E, a rear dielectric layer 130 may be formed on the rear substrate 110 provided with the address electrode 120. The rear dielectric layer 130 may be formed using a screen printing method or a green sheet laminating method using a low-melting point glass and a filler such as TiO2. In certain embodiments, the dielectric layer 130 renders white to improve the brightness of plasma display panels. For simplification of the overall process, the rear dielectric layer 130 and the address electrode 120 may be baked through a one-step process.

Thereafter, as shown in FIGS. 8F to 8I, barrier ribs 140 to define discharge cells may be formed on the white dielectric layer 130. First, as shown in FIG. 8F, a barrier rib paste 140a may be applied onto the white dielectric layer 130. The application of the barrier rib paste 140a may be carried out using a spray coating method, a bar coating method, a screen printing method or a green sheet method. In certain embodiments, the barrier rib paste 140 is prepared into a green sheet and then laminated. The patterning of the barrier rib paste 140a may be carried out by sanding, etching, and photosensitive paste method. Hereinafter, the etching method will be described in detail.

Then, as shown in FIG. 8G, dry film resists (DFR) 155 may be formed over the barrier rib paste 140a such that they are uniformly spaced apart from each other. In certain embodiments, the DFRs 155 are formed at positions for forming barrier ribs 140.

As shown in FIG. 8H, the barrier rib paste 140a may be patterned to form barrier ribs 140. That is, when an etching solution is sprayed from the top of the DFR 155, the barrier rib material in the regions where the DFRs 155 are not provided is gradually etched, and thus patterned into a barrier rib shape. Then, the DFRs 155 may be removed. After removing the etching solution through a washing process, baking may be performed to complete the barrier rib structure as shown in FIG. 8I.

As mentioned above, the barrier ribs 140 may be of a stripe type, a well type, or a delta type.

Subsequently, the barrier ribs 140 may be dried and baked. The drying of the barrier ribs may be carried out at a temperature ranging from about 50° C. to about 250° C. for about 5 to 90 minutes. The curing may be carried out at a temperature ranging from about 300° C. to about 600° C. for about 30 to 60 minutes.

Then, as shown in FIG. 8J, phosphor layers 150 may be applied over the surfaces of the white dielectric layer 130 facing discharge spaces and the side surfaces of the barrier ribs 140. The application of phosphor layers 150a, 150b and 150c may be performed such that R, G, and B phosphors are sequentially applied in each discharge cell. The application may be carried out using a screen printing method or a photosensitive paste method.

Hereinafter, a process for preparing a phosphor paste will be discussed.

First, an organic binder is mixed with a solvent to prepare a vehicle. The vehicle may be prepared by mixing about 5 to 80% by weight of the organic binder and about 20 to 95% by weight of the solvent.

0] Then, a phosphor powder may be mixed with the vehicle to prepare a first phosphor paste. The first phosphor paste may be prepared by mixing about 20 to 90% by weight of the vehicle with about 10 to 80% by weight of the phosphor powder.

Subsequently, a thermal decomposition catalyst may be mixed with the first phosphor paste to prepare a second phosphor paste. The second phosphor paste may be prepared by mixing about 64 to 99.999% by weight of the first phosphor paste with about 0.001 to 36% by weight of the thermal decomposition catalyst. The thermal decomposition catalyst may be Zeolite, a metal oxide nanopowder or a combination thereof.

Then, a solvent may be mixed with the second phosphor paste. The second phosphor paste and the solvent may be mixed in amounts of about 5 to 80% by weight and about 20 to 95% by weight, respectively.

Then, the resulting second phosphor paste may be applied to discharge cells of a lower substrate of a plasma display panel to form a phosphor layer.

1 Subsequently, the phosphor layer may be dried and baked to remove organic residues left on the phosphor layer. The drying of the phosphor layer may be carried out at a temperature ranging from about 50° C. to about 250° C. for about 5 to 90 minutes. The baking of the dried phosphor layer may be carried out at a temperature ranging from 300° C. to 600° C. for about 30 to 60 minutes, under vacuum or inert gas atmosphere.

Then, as shown in FIG. 8K, the upper panel may be joined with the lower panel such that the barrier ribs 140 are interposed between the two panels, and then sealed. After the internal impurities of the panels are discharged to the outside, a discharge gas 160 may be fed into the space between the panels.

Sealing the upper panel with the lower panel may be performed with a screen printing method, a dispensing method, or the like.

In accordance with the screen printing method, patterned screens are placed on the substrate such that the screens are spaced by a predetermined distance apart from each other, and a paste for a sealant is then pressed and transcribed to print a desired pattern of sealant. The screen printing method has the advantages of simple fabrication equipment and high material utilization efficiency.

In accordance with the dispensing method, a thick film paste is discharged onto a substrate via an air pressure using CAN wiring data used to produce screen masks to form a sealant. The dispensing method has advantages in that mask production cost is saved and the shape of a thick film has a high freedom degree.

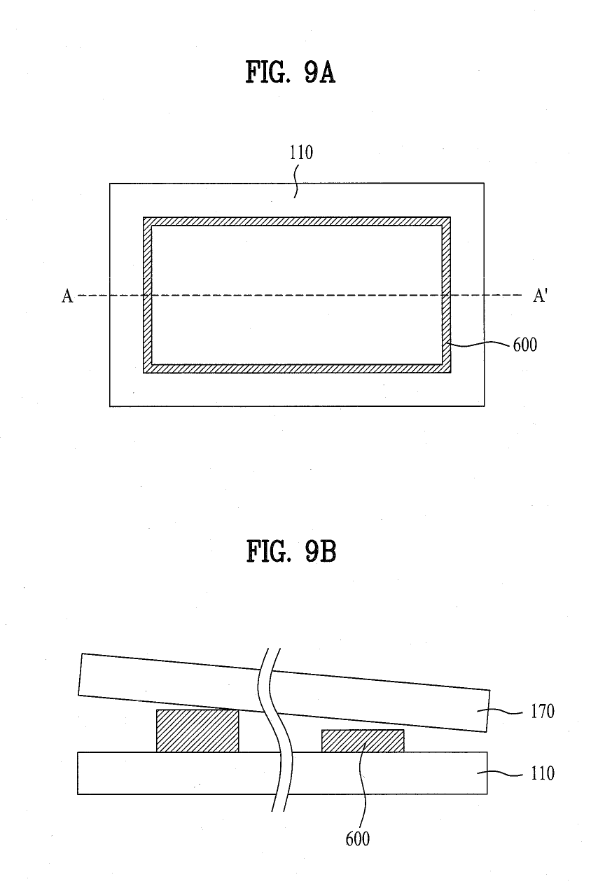

FIG. 9A illustrates a process for joining a front substrate 170 and a rear substrate 110 of a plasma display panel. FIG. 9B is a sectional view taken along line A-A′ of FIG. 9A.

As shown in FIGS. 9A and 9B, a sealant 600 may be applied onto the front substrate 170 or the rear substrate 110. Specifically, a sealant may be applied onto the substrate by printing or dispensing simultaneously with a predetermined space apart from the outermost of the substrate.

Thereafter, the sealant 600 may be baked. During the baking, the organic materials contained in the sealant 600 are removed, and the front substrate 170 and the rear substrate 110 are joined together. In this baking process, the sealant 600 may be widened and thickened. In this embodiment, the sealant 600 is printed or applied onto the substrate. Alternatively, a sealant in the form of a tape may be adhered onto the front or rear substrate.

Then, an aging process may be performed to improve the characteristics as a passivation film, etc. at a predetermined temperature.

Subsequently, a front filter may be formed over the front substrate 170. The front filter may be provided with an electromagnetic interference (EMI) shield film to prevent EMI from emitting out from the panel. The EMI shield film may be patterned into a specific shape using a conductive material to ensure the visible light transmittance required in the display device, while shielding EMI. The front filter may also include a near infrared shield film, a color compensation film, and an anti-reflection film.

As apparent from the foregoing, a phosphor layer of a plasma display panel produced according to embodiments as broadly described herein may minimize organic residues left therein, thus exhibiting improved phosphor color characteristics.

Furthermore, this improvement in phosphor color characteristics may enhance overall brightness and luminescence efficiency of the plasma display panel.

An improved phosphor paste may improve brightness, luminescence efficiency and color characteristics via minimization of organic residues left on phosphor layers, and a plasma display panel using such a phosphor paste is provided.

A phosphor paste as embodied and broadly described herein may include a vehicle consisting of an organic binder and a solvent; a phosphor powder; and a thermal decomposition catalyst promoting oxidative thermal decomposition of the organic binder, the thermal decomposition catalyst consisting of Zeolite and a metal oxide nanopowder with a particle size of 10 to 1,000 nm.

The Zeolite may be used in an amount of 0.1 to 50% by weight, based on the weight of the organic binder.

The Zeolite may be at least one selected from Zeolite A, Zeolite X, Zeolite Y, Zeolite ZSM-5, Zeolite ZSM-11, Mordenite and habazite.

The metal oxide nanopowder may be used in an amount of 0.1 to 70% by weight, based on the weight of the organic binder.

The metal oxide nanopowder may be at least one selected from Al2O3, 3Al2O3, 2SiO2, Al2O3 ZrO2, ZrO4, TiSiO4, Al2O3 TiO2, MgO and SiO2.

The thermal decomposition catalyst may consist of 1 to 60% by weight of the Zeolite and 40 to 99% by weight of the metal oxide nanopowder.

A plasma display panel as embodied and broadly described herein may include a first substrate including a first electrode; a second substrate facing the first substrate, the second substrate including a second electrode; barrier ribs arranged between the first substrate and the second substrate, the barrier ribs partitioning discharge cells; and a phosphor layer arranged in each of the discharge cells, the phosphor layer including a thermal decomposition catalyst consisting of Zeolite and a metal oxide nanopowder with a particle size of 10 to 1,000 nm.

The thermal decomposition catalyst included in the phosphor layer may be used in an amount of 0.001 to 36% by weight.

Any reference in this specification to “one embodiment,” “an embodiment,” “example embodiment,” “certain embodiment,” “alternative embodiment,” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A plasma display panel, comprising:
a first substrate including a first electrode;
a second substrate facing the first substrate, the second substrate including a second electrode;
barrier ribs arranged between the first substrate and the second substrate so as to define a plurality of discharge cells therebetween; and
a phosphor layer provided in each of the discharge cells, wherein the phosphor layer includes Zeolite and a metal oxide nanopowder.

2. The plasma display panel of claim 1, wherein a particle size of the metal oxide nanopowder is between approximately 10 and 1000 nm.

3. The plasma display panel of claim 1, wherein the phosphor layer further comprises a phosphor powder.

4. The plasma display panel of claim 3, wherein the Zeolite and the metal oxide nanopowder are included in a thermal decomposition catalyst that promotes oxidative thermal decomposition of an organic binder used to mix the Zeolite, the metal oxide nanopowder and the phosphor powder, and wherein an amount of the thermal decomposition catalyst included in the phosphor layer is 0.001 to 36% by weight.

5. The plasma display panel of claim 1, wherein the Zeolite is at least one of Zeolite A, Zeolite X, Zeolite Y, Zeolite ZSM-5, Zeolite ZSM-11, Mordenite or habazite.

6. The plasma display panel of claim 1, wherein the metal oxide nanonowder is at least one of Al₂O₃, 3Al₂O₃, 2SiO₂, Al₂O₃ZrO₂, ZrO₄, TiSiO₄, Al₂O₃TiO₂, MgO or SiO₂.

7. The plasma display panel of claim 3, wherein the Zeolite and the metal oxide nanopowder are included in a thermal decomposition catalyst that promotes oxidative thermal decomposition of an organic binder used to mix the Zeolite, the metal oxide nanopowder and the phosphor powder, and wherein the thermal decomposition catalyst comprises 1 to 60% by weight of the Zeolite and 40 to 99% by weight of the metal oxide nanopowder.

8. The plasma display panel of claim 3, wherein the Zeolite and the metal oxide nanopowder are included in a thermal decomposition catalyst that promotes oxidative thermal decomposition of an organic binder used to mix the Zeolite, the metal oxide nanopowder and the phosphor powder, and wherein the thermal decomposition catalyst comprises 30 to 40% by weight of the Zeolite and 60 to 70% by weight of the metal oxide nanopowder.

9. A method producing a phosphor layer of a plasma display panel (PDP), the method comprising:
mixing an organic binder and a solvent to prepare a vehicle;
mixing the vehicle with a phosphor powder to prepare a first phosphor paste;
mixing the first phosphor paste with a thermal decomposition catalyst to prepare a second phosphor paste;
mixing the second phosphor paste with a solvent to prepare a second phosphor paste mixture;
applying the second phosphor paste mixture to a substrate; and
drying and curing the second phosphor paste mixture produce a phosphor layer on the substrate.

10. The method of claim 9, wherein mixing an organic binder and a solvent to prepare a vehicle comprises mixing about 5 to 80% by weight of the organic binder and about 20 to 95% by weight of the solvent to prepare the vehicle.

11. The method of claim 10, wherein mixing the vehicle with a phosphor powder to prepare a first phosphor paste comprises mixing about 20 to 90% by weight of the vehicle with about 10 to 80% by weight of the phosphor powder to prepare the first phosphor paste.

12. The method of claim 11, wherein mixing the first phosphor paste with a thermal decomposition catalyst to prepare a second phosphor paste comprises mixing about 64 to 99.99% by weight of the first phosphor paste with about 0.001 to 36% by weight of the thermal decomposition catalyst.

13. The method of claim 11, wherein mixing the first phosphor paste with a thermal decomposition catalyst to prepare a second phosphor paste comprises mixing the first phosphor paste with Zeolite in an amount of about 0.1 to 50% by weight based on a weight of the organic binder.

14. The method of claim 11, wherein mixing the first phosphor paste with a thermal decomposition catalyst to prepare a second phosphor paste comprises missing the first phosphor paste with a metal oxide nanopowder in an amount of about 0.1 to 70% by weight based on a weight of the organic binder.

15. The method of claim 11, wherein mixing the first phosphor paste with a thermal decomposition catalyst to prepare a second phosphor paste comprises mixing the first phosphor paste with Zeolite in an amount of about 0.1 to 50% by weight, and a metal oxide nanopowder in an amount of about 0.1 to 70% by weight, based on a weight of the organic binder.

16. The method of claim 11, wherein mixing the first phosphor paste with a thermal decomposition catalyst to prepare a second phosphor paste comprises mixing the first phosphor paste with a thermal decomposition catalyst comprising about 1 to 60% by weight of Zeolite and about 40 to 99% by weight of a metal oxide nanopowder.

17. The method of claim 12, wherein mixing the second phosphor paste with a solvent to prepare a second phosphor paste mixture comprises mixing about 5 to 80% by weight of the second phosphor paste and about 20 to 95% by weight of the solvent to produce the second phosphor paste mixture.

18. The method of claim 17, wherein drying and curing the second phosphor paste mixture to produce a phosphor layer on the substrate comprises:
drying the phosphor layer at a temperature of about 50° C. to 250° C. for about 5 to 90 minutes; and
curing the dried phosphor layer at a temperature of about 300° C. to 600° C. for about 30 to 60 minutes.

19. The method of claim 18, wherein drying and curing the second phosphor paste mixture to produce a phosphor layer on the substrate comprises producing a phosphor layer comprising 3 to 14.4% by weight of the Zeolite, 6 to 25.2% by weight of the metal oxide nanopowder, and 64 to 99.99% by weight of the phosphor powder.

20. The method of claim 9, wherein the second phosphor paste comprises about 20 to 90 by weight of the vehicle, about 10 to 80% by weight of the phosphor powder, and about 0.001 to 36% by weight of the thermal decomposition catalyst.
